(19) United States
(12) Patent Application Publication
(10) Pub. No.: US 2008/0033752 A1
(43) Pub. Date: Feb. 7, 2008

(54) METHODS AND SYSTEMS FOR MONITORING STAFF/PATIENT CONTACTS AND RATIOS

(75) Inventor: Mark E. Rodgers, Jackson, MI (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Valence Broadband, Inc., Ridgeland, MI (US)

(21) Appl. No.: 11/774,471

(22) Filed: Jul. 6, 2007

Related U.S. Application Data
(63) Continuation of application No. 11/608,125, filed on Dec. 7, 2006.
(60) Provisional application No. 60/835,662, filed on Aug. 4, 2006.

(51) Int. Cl. G06Q 50/00

(52) U.S. Cl. 705/2

(57) ABSTRACT

Methods, systems and computer program products are used in monitoring patients, staff, and assets at a facility, initiating a response to prevent or mitigate harm, and assess and ensure overall quality and performance, and refine individual patient profiles. A plurality of sensors throughout the facility provides multiple data streams relating to the locations of patients relative to caregivers. A computer system analyzes the data stream and determines the location and/or movements of the patients relative to the caregivers. Patient profiles are periodically refined by means of an information feedback loop in order to more accurately predict (actionable) events, provide adequate care and ensure a desired level of patient wellness. From the analyzed data, staff-to-patient contact times and staff-to-patient ratios are determined. When abnormalities in staff-to-patient contact times and/or staff-to-patient ratios are detected, facility staff can be notified.

### CROSS-REFERENCE TO RELATED APPLICATION

This application is a continuation-in-part of U.S. application Ser. No. 11/608,125, filed Dec. 7, 2006 and also claims the benefit of co-pending U.S. provisional application Ser. No. 60/835,662, filed Aug. 4, 2006. The disclosures of the foregoing applications are incorporated herein in their entirety.

### BACKGROUND OF THE INVENTION

1. Field of the Invention

The invention is in the field of patient monitoring systems and methods for assessing and ensuring a level of quality and performance provided by a healthcare facility. The invention more particularly relates to monitoring staff-to-patient contact times and ratios at a healthcare facility.

2. Relevant Technology

Healthcare facilities provide clinical and/or wellness health care for patients and/or residents (hereinafter collectively referred to as “patients”) at such facilities. Hospitals and medical clinics provide clinical health care. Assisted living and nursing homes focus primarily on wellness health care. Most facilities provide at least some monitoring and supervision of patients to ensure they are receiving proper nutrition and medicines, are kept clean, and are protected from physical injury. A central station (e.g., a nursing station) typically functions as a primary gathering and dispatch location for caregivers. At specified intervals, or in response to a patient or resident request, a caregiver can move from the central station to a patient's location (e.g., room) and monitor or provide appropriate care.

There are often tradeoffs between ensuring that every patient at a facility receives a required level of basic care while also providing individualized care and initiating appropriate responses based on a patient's specific behaviors, attributes and needs. Even though all patients may receive the same basic level of care, some may receive too much care and others not enough care due to discrepancies between the basic standards of care and a patient's actual needs. The result is an inefficient allocation of resources that compromises the overall quality and performance of a facility and individual staff members.

Notwithstanding the need to monitor and supervise patients to ensure an adequate level of quality and performance and prevent patient injury, the United States, Europe, Japan and other parts of the world are currently experiencing a serious shortage of nurses, nursing assistants, doctors, and other caregivers. Such shortage will only worsen with continued aging of the population. As the patient to caregiver ratio at a facility increases, the ability to provide adequate patient care and protection (e.g., sufficient staff-to-patient contact time) are likely to decrease as more patients are left unattended. There is therefore an acute need for new methods and systems that generally insure sufficient staff-to-patient ratios and more specifically insure sufficient staff-to-patient contact time for each patient, while also reducing facility liability, enhancing caregiver productivity, and lowering operational expenses.

In view of the foregoing, it would be an advancement in the art to provide methods and systems for monitoring patient and staff populations, activities and interactions to generally increase the overall quality and performance of the facility and also increase the overall quality and performance in providing for the specific needs of a patient as among a plurality of different patients.

### SUMMARY OF THE INVENTION

The present invention relates to patient monitoring methods and systems used to monitor staff-to-patient contact time and staff-to-patient ratios at a healthcare facility. Real time data regarding the locations, movements and/or behaviors of each of a plurality of patients, caregivers, and assets is obtained from multiple sources and analyzed by a computer system (e.g., facility master). The computer system meaningfully interprets the data to update and track staff-to-patient contact times through the use of individualized patient specific profiles and to track staff-to-patient ratios for a facility and/or departments thereof. When staff-to-patient contact time or staff-to-patient ratio specific limit is approached or breeched, the computer system may initiate an appropriate response to insure that sufficient care is available and/or given to patients, such as, for example, increasing staff-to-patient contact time, increasing staff levels, etc.

Data regarding the location, movements and/or interactions of patients and staff throughout or outside a facility can be continuously gathered using any detection means known in the art including, but not limited to, RFID devices, an RFID detection grid, GPS devices, ultrasound devices, ultrasound detection grid, cameras, motion detectors, light beam detectors, image analysis systems and the like. For example, various sensors can be used to detect the number and type of staff members present at a facility or in a specified location at a facility, to detect the number of patients present at a facility or in a specified location at a facility, or to detect common occupancy of a staff member and a patient at a location in or outside of the facility.

Staff-to-patient ratios can be (potentially continuously) determined from received sensor data and compared to pre-determined sufficient staff-to-patient ratios values to insure that staffing at a facility (or portion thereof) is adequate. If abnormal staff-to-patient ratios are detected, alerts or alarms can be sent to appropriate facility personnel.

The duration of staff-to-patient contact times can also be established, verified and refined through the use of specific patient profiles. By refining patient specific profiles based on gathered data, such as, for example, indications of when a staff member and a patient commonly occupy a portion of space at a facility, the inventive systems and methods are able to interpret behaviors, conditions and events in a highly individualized manner as among different patients at a healthcare facility.

Thus, a patient profile can include cumulative staff-to-patient contact time values, as well as other types of static and dynamic data relating to a plurality of specific care and wellness parameters. Profile data can be uploaded to networked or peripheral computers as needed to carry out monitoring cumulative staff-to-patient contact time. An information feedback loop can be used to update each patient profile, which may occur automatically or manually, in order to create and maintain a current database of patient status, attributes and needs. If abnormal staff-to-patient contact time values are detected, alerts or alarms can be sent to appropriate facility personnel.

These and other advantages and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 schematically illustrates an exemplary facility monitoring master system;

FIG. 2 schematically illustrates exemplary computer architecture that facilitates facility, patient, staff and/or asset monitoring;

FIG. 3 is a flow chart that illustrates an exemplary method for tracking cumulative staff-to-patient contact time using individualized patent profiles.

FIG. 4 is a flow chart that illustrates an exemplary method for tracking staff-to-patient ratios for a healthcare facility.

FIG. 5 schematically illustrates the interrelationship of various data gathering and analysis modules used to maintain and refine a patient profile;

FIG. 6 is a flow chart that illustrates an exemplary method for maintaining cumulative staff-to-patient contact time for a patient.

### DETAILED DESCRIPTION OF THE PREFERRED EMBODIMENTS

### I. Introduction

Embodiments of the present invention extend to methods, systems, and computer program products for monitoring staff-to-patient contact times and staff-to-patient ratios at a healthcare facility based on general healthcare standards as well as each patient's general and individualized needs.

Patient specific data, including cumulative staff-to-patient contact times, can be tracked and maintained for each patient to create a database of generalized and personalized knowledge. Profile specific data can be used to monitor quality and performance at a facility and helps ensure that each patient at the facility receives a prescribed level of care. To be sure, there are general aspects and levels of patient care and wellness that may be substantially similar for some or all patients, including the need for adequate rest, nutrition, cleanliness, safety, privacy, some amount of staff-to-patient contact time, having sufficient staff present at the facility (e.g., monitored as one or more staff-to-patient ratios), and the like. On the other hand, some or all patients may require specialized care and have different criteria based on individual patient needs (e.g., based on age, physical capacity, mental capacity, and the like).

The quality and performance systems and methods of the invention monitor care and wellness for each patient by means of automated tracking of patients, caregivers and a assets used to deliver care. The inventive methods and systems track patient location, activities, condition, and regimen completion, as well as assigned caregiver and asset location, activities and regimen completion. Care and wellness are measured generally as well as in relation to individual patient profiles which are maintained and periodically refined for each patient. According to one embodiment, the methods and system initiate responses to pre-determined triggering events to prevent or mitigate patient harm or to remedy other deficiencies related to patient care.

The methods and systems are implemented using a computer-controlled electronic patient monitoring system that receives and analyzes data generated by a network of electronic data generating devices. A profile maintenance and refinement sub-system and method is used to periodically update and refine patient profiles, as well as track facility wide parameters, as data is received and analyzed for the facility as well as individual patients and staff. The care and wellness of a patient, as well as the performance of staff, can be analyzed and improved through the use of individually refined profiles.

The term “patient profile” shall refer to stored data that is associated with a specific patient at a healthcare facility. Patient profiles typically include static data and dynamic data. Dynamic data refers to limits and alarms that are continuously or periodically updated or refined based on information learned about the patient and/or changing patient needs or requirements. Dynamic data can be automatically updated in response to events or it may be manually updated by staff after an event.

The terms “care” and “wellness” shall be broadly understood to cover every aspect of a patient's life and well being that are relevant to care and treatment at a health facility. Care more particularly relates to treatments, activities and regimens that are provided to the patient in order to ensure a prescribed or minimum level of general health and well-being. Wellness is a measure of the general health and well-being of the patient. Care and wellness affect the overall quality and performance of a healthcare facility.

The terms “continuous monitoring” and “continuous video data stream” include taking a series of images that may be spaced apart by any appropriate time interval so long as the time interval is sufficiently short that the system is not unduly hampered from initiating a response in time to prevent or mitigate a potentially dangerous event.

The terms “receiving” and “inputting” in the context of a patient profile broadly includes any action by which a complete or partial patient profile, or any component thereof, is stored or entered into a computer system. This includes, but is not limited to, creating a profile and then storing or entering it into a computer, entering data which is used by the computer to generate a new patient profile, and/or storing or entering data used by a computer for updating a pre-existing patient profile already in the computer.

The term “staff-to-patient contact time” shall be broadly understood as the detection (e.g., via RFID or ultrasound) of a staff member and a patient within a specified physical proximity of one another, either inside or outside a facility. This includes, but is not limited to, a staff member and a patient occupying the same room and a staff member and a patient occupying the same portion of a common area. The specified physical proximity to a patient can be varied in a patient profile based on the physical and/or mental capabilities of a patient.

Staff-to-patient contact time can also be stratified across different staff subgroups. Staff subgroups can be divided by skill level, position, type of work, etc. For example, separate cumulative staff-to-patient contact time values can be maintained for as corresponding different staff subgroups, such as, doctors, nurses, nursing assistants, physical therapy personnel, occupational therapy personnel, house cleaning personnel, cafeteria personnel, social work personnel, speech therapy personnel, etc. A contact time threshold can be used to filter out non-meaningful contact, such as, for example, when patient and staff members merely pass each other in the hall.

The term “staff-to-patient ratio” shall be broadly understood as the ratio of staff members of a healthcare facility (or portion thereof) to patients of the healthcare facility (or portion thereof). Staff-to-patient ratios can be stratified across staff subgroups. For example, a doctor-to-patient ratio, a nurse-to-patient ratio, speech therapy personnel-to-patient ration, etc., can be tracked for a healthcare facility. Staff-to-patient ratios can also be stratified by department for an entire health care facility or for a department. For example, a radiology department staff-to-patient ratio can be tracked for an entire healthcare facility. Alternately, a critical care unit staff-to-critical care unit patient ratio can be tracked. Combinations of ratios considering types of staff members and departments are also possible.

Different combinations of staff member subgroups can also be viewed collectively when calculating staff-to-patient ratios (for an entire facility or per department). For example, staff members that can provide some level of health care (e.g., doctors, nurses, nursing assistants, orderlies, etc.) can be considered, while other staff members that do not provide health care (e.g., cafeteria workers, janitors, security personnel, etc.) are not necessarily considered.

Those skilled in the art will appreciate that the invention may be practiced in network computing environments with many types of computer system and electronic device configurations, including, personal computers, desktop computers, laptop computers, hand-held devices, multi-processor systems, microprocessor-based or programmable consumer electronics, network PCs, minicomputers, mainframe computers, mobile telephones, PDAs, one-way and two-way pagers, Radio Frequency Identification (“RFID”) devices (e.g., bracelets, tags, etc.), ultrasound devices (e.g., bracelets, tags, etc.), global position (“GPS”) devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present invention may comprise or utilize a special purpose or general-purpose computer including computer hardware, as discussed in greater detail below. Embodiments within the scope of the present invention also include physical and other computer-readable media for carrying or having computer-executable instructions or data structures stored thereon. Such computer-readable media can be any available media that can be accessed by a general purpose or special purpose computer system. Computer-readable media that store computer-executable instructions are physical storage media. Computer-readable media that carry computer-executable instructions are transmission media.

Thus, by way of example, and not limitation, computer-readable media can comprise physical storage media or transmission media. Physical storage media can include RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network or data links which can be used to carry or desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

### II. Computer-Implemented Electronic Patient Monitoring System and Method for Measuring and Verifying Quality and Performance

A. Exemplary System Architecture

According to one currently preferred embodiment, the quality and performance monitoring systems and methods of the inventions are implemented by means of a computer system. The computer system may include one or more centralized computers, referred to as a “facility master”, and one or more localized computers, exemplified by one or more “in room controllers”. The various computers within the overall computer system divide up the task of receiving and analyzing data gathered from the overall patient monitoring system.

A facility master computer system can receive data regarding patients, staff, and assets from a variety of data collection clients within and outside a facility. Data collection clients can include, for example, in room controller clients, room associated clients, care giver system clients, facility patient, staff, and asset tracking and location clients, and external facility patient, staff and asset tracking clients. The data gathered or generated by the data collection clients is sent to the facility master computer system by means of communication pathways (e.g., IEEE 802.xx wireless, RFID, ultrasound, GPS, etc.) for analysis, response, and report. In some cases, a localized computer, such as an in room controller client and/or, may perform its own analysis of gathered data in order to compartmentalize or bifurcate the tasks provided by the various computers of the computer system in order to more efficiently use the computer system resources and reduce bottle necks.

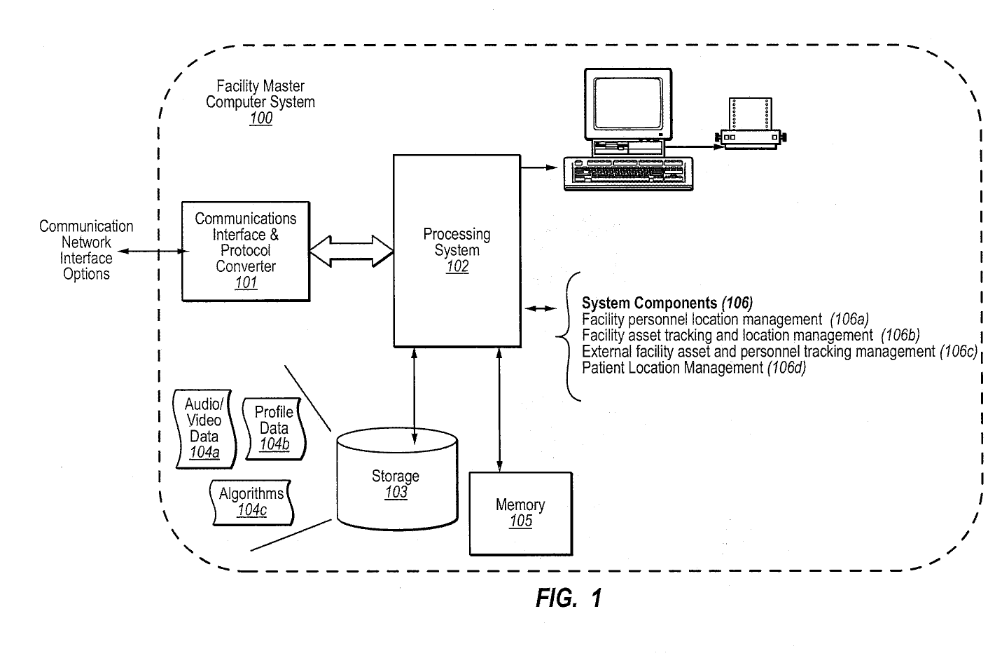

FIG. 1 schematically illustrates an exemplary facility master computer system 100 that can be used to control and implement quality and performance monitoring systems and methods according to the invention. Communications interface and protocol converter 101 can receive communications in accordance with various protocols of and can convert the communication so as to be compatible with a processing system 102. Storage 103 can store data used and produced by the processing system 102, examples of which include archived audio/video data 104a (e.g., archived in response to detection of an actionable event), profile data 104b (e.g., patient and staff data), and algorithms 104c used to process data and initiate appropriate responses and reports. Memory 105 can be used to buffer and quickly access short term data used or generated by the processing system 102.

The facility master computer system 100 includes exemplary system components 106, which are modules or applications that process data gathered by data collection and processing devices. Some of these modules or applications can also be run, at least in part, by local computers, such as in room controller clients (not shown). These modules can include facility personnel location management 106a, facility asset tracking and location management 106b, external facility asset and personnel tracking management 106c, and patient location management 106d.

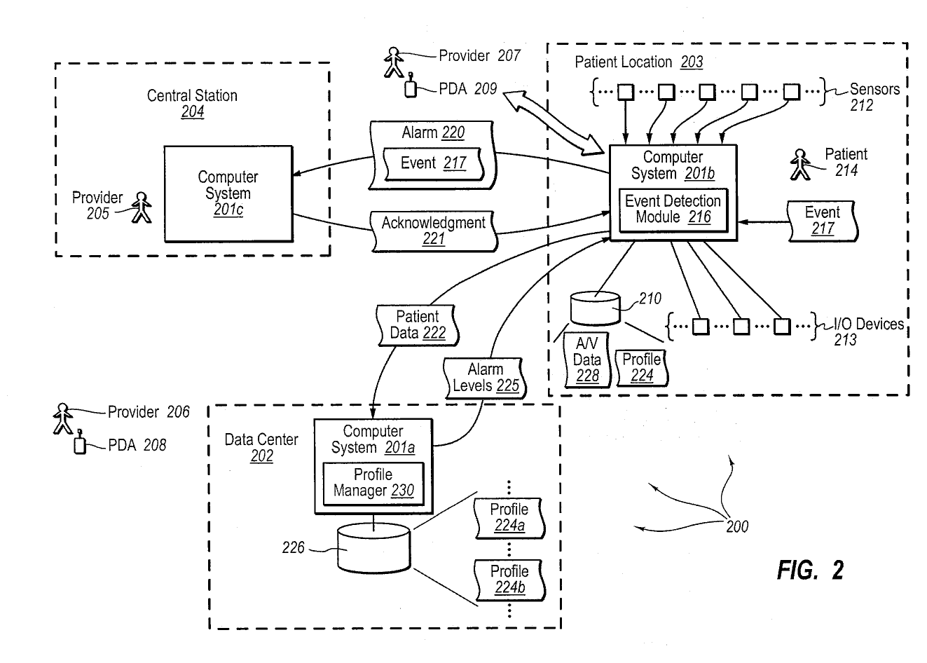

FIG. 2 illustrates an exemplary computer-implement monitoring system 200 that monitors patients, staff, and assets, assesses quality and performance, and manages event responses at a healthcare facility. Monitoring system 200 includes a networked computer system 201, which is composed of a main computer system 201a (e.g., facility master) located in a data center 202, first peripheral computer system 201b (e.g., in room controller client) at patient location 203, and second peripheral computer system 201c at a central station (e.g., nurse's station). Each computer system 201a-c can be connected to a network, such as, for example, a Local Area Network (“LAN”), a Wide Area Network (“WAN”), or even the Internet. The various components can receive and send data to each other, as well as other components connected to the network. Networked computer systems constitute a “computer system” for purposes of this disclosure.

Networks facilitating communication between computer systems and other electronic devices can utilize any of a wide range of (potentially interoperating) protocols including, but not limited to, the IEEE 802 suite of wireless protocols, Radio Frequency Identification (“RFID”) protocols, ultrasound protocols, infrared protocols, cellular protocols, one-way and two-way wireless paging protocols, Global Positioning System (“GPS”) protocols, wired and wireless broadband protocols, ultra-wideband “mesh” protocols, etc. Accordingly, computer systems and other devices can create message related data and exchange message related data (e.g., Internet Protocol (“IP”) datagrams and other higher layer protocols that utilize IP datagrams, such as, Transmission Control Protocol (“TCP”), Remote Desktop Protocol (“RDP”), Hypertext Transfer Protocol (“HTTP”), Simple Mail Transfer Protocol (“SMTP”), Simple Object Access Protocol (“SOAP”) etc.) over the network.

In some embodiments, a multi-platform, multi-network, multi-protocol, wireless and wired network architecture is utilized to monitor patient, staff, and asset locations, movements, and interactions within a facility. Computer systems and electronic devices may be configured to utilize protocols that are appropriate based on corresponding computer system and electronic device on functionality. For example, an electronic device that is to send small amounts of data a short distance within a patient's room can be configured to use Infrared protocols. On the other hand, a computer system configured to transmit and receive large database records can be configured to use an 802.11 protocol. Components within the architecture can be configured to convert between various protocols to facilitate compatible communication. Computer systems and electronic devices may be configured with multiple protocols and use different protocols to implement different functionality. For example, an in room controller or other computer system 201b at patient location 203 can receive patient data via infrared from a biometric monitor and then forward the patient data via fast Ethernet to computer system 201a at data center 202 for processing.

In some environments, ultrasound technologies, such as, for example, those developed by Sonitor Technologies, may be preferred for monitoring patient, staff, and asset locations, movements, and interactions within a facility. Ultrasound waves can be blocked by normal walls, are less likely to reflect off of metallic objects, and are less likely to interfere with sensate instruments. For example, ultrasound waves can be confined to a room (e.g., a patient room) where they originate. When using ultrasound receivers and detectors, various Digital Signal Processing (DSP) algorithms can be used to convert ultrasound waves into meaningful digital data (e.g., for transport on a wired network). The DSP algorithms can be configured to ensure that ultrasound detectors interpret ultrasound waves without risk of interference from any environmental noise or other signals nor interference with sensitive instruments.

However, in other environments the increased range of RFID may be preferred for monitoring patient, staff, and asset locations, movements, and interactions within a facility. For example, since RFID signals can pass through walls, RFID detection systems can be implemented with fewer detectors.

Computer system 201c can be physically located at a central station 204 of a healthcare facility, e.g., a nursing station. Provider 205 (a nurse or other healthcare worker) can be physically located near computer system 201c such that provider 205 can access electronic communications (e.g., alarm 220, video feeds, A/V communications) presented at computer system 201c. Acknowledgment 221 can be sent to other computer C systems 201a, 201b as appropriate to verify that alarm 220 was considered by provider 205. Other healthcare providers, such as providers 206 and 207, can be physically located in other parts of a healthcare facility. Healthcare providers can move between different locations (e.g., central station 204, patient rooms, hallways, outside the building, etc.). Accordingly, healthcare providers 206, 207 can also carry mobile computer systems (e.g., laptop computers or PDAs 208 and 209) and other types of mobile devices, (e.g., pagers, mobile phones, GPS devices, RFID devices, ultrasound devices). As providers 206, 207 move about a healthcare facility they can still access electronic messages (e.g., alarms) and send messages.

Computer system 201b, storage device 210, sensors 212, and I/O devices 213 can be physically located at patient location 203, such as patient rooms, common areas, hallways, and other appropriate locations throughout or outside a healthcare facility. For example, patient location 203 can be a room of a patient 214. Sensors 212 can include various types of sensors, such as, for example, video cameras, still cameras, microphones, motion sensors, acoustic sensors, RFID detectors, ultrasound detectors, global positioning sensors (“GPS”), etc. Although depicted separately, I/O devices 213 can also be sensors. Sensors and I/O devices can also send data to any appropriate computer system for processing and event detection, including either or both of computer systems 201a and 201c.

Some sensors 212 can be stationary (e.g., mounted at patient location 203) such that the sensors sense patient, staff, or asset characteristics when within a specified vicinity of the sensor 212. Other sensors can be mobile and move with a patient, provider, or asset as they move about a healthcare facility. As a patient, provider, or asset moves about a healthcare facility, different combinations of stationary and mobile sensors can monitor the patient, provider, or asset at different locations and/or times.

Each of sensors 212 can provide input to computer system 201b. Event detection module 216 can monitor and process inputs from sensors 212 to detect if a combination of inputs indicates the occurrence of a potentially actionable event 217. Detecting the occurrence of event 217 can trigger the transfer of various electronic messages from computer system 201b to other networked computers of the monitoring system 200. For example, electronic messages (alarm messages 220 regarding event 217) can be transferred to computer system 201c and/or mobile devices to alert health care providers of an actionable event 217. Alternatively or in addition, electronic messages including patient data 222 can be transferred to other computer systems, such as computer system 201a, that process the patient data 222 (e.g., for refining patient profiles 224 stored in storage 226). Alarm levels 225 can be sent to computer system 201b for use in determining whether an event 217 is actionable.

One or more of sensors 212 can be used to detect patient conditions or performance, such as, for example, staff-to-patient contact times, etc. Computer system 201b can buffer sensor input at storage device 210 for some amount of time before discarding the input (e.g., video data). In response to detecting the occurrence of an event 217, computer system 201b can locally archive sensor input or data from I/O devices 213 at storage device 210 (e.g., A/V data 228). Buffered and/or archived sensor input can provide the basis for patient data 222 that is transferred to other computer systems.

Event occurrences, for example, insufficient cumulative staff-to-patient contact time, can be detected in accordance with a profile associated with a monitored patient. Patient profiles 224, either accessed directly from computer system 201a or stored locally in storage 210, can be used to analyze data from sensors 212. Alternatively, alarm levels 225 can be used independently of a patient profile 224 by local computer system 201b. Based on differing patient profiles 224 and/or alarm levels 225 for a plurality of patients, a combination of inputs detected as the occurrence of an (actionable) event 217 for one patient is not necessarily detected as the occurrence of an (actionable) event 217 for another patient, and vice versa. An actionable event can be detected when a specified alarm level for a given patient is satisfied. For example, a specified combination of risk behaviors and/or vital signs can cause an actionable event to be detected.

Computer system 201a and storage device 226 can be physically located at data center 202. Storage device 226 can store profiles (e.g., profiles 224a and 224b) for patients and staff. Profile manager 230 can receive patient data 222 sent to computer system 201a (e.g., in response to a detected event) and refine a corresponding patient profile 224 in accordance with the patient data 222. As data related to a patient 214 changes, the patient's profile 224 can be modified to indicate changed risks, limits and alarm levels for the patient 214. Risk profiles for a patient can be iteratively refined as patient data 222 for the patient 214 is received. Algorithms for refining profiles can be recursed on a per iteration basis.

Patients, providers, and assets may carry RFID transmitting devices, each having a unique signature such that an RFID transmitting device can be used to determine the location of a patient, provider, or asset within a healthcare facility. RFID transmitting devices can be non-removable, such as a bracelet or an adhesively attached pad, or removable, such as an employee badge. Transmitted RFID signals can be detected by RFID receivers, which are examples of sensors that can be included in sensors 212.

Alternately, patients, providers, and assets may carry Ultrasound transmitting devices that can be used to determine patient, provider and asset locations within a healthcare facility. Transmitted Ultrasound waves can be detected by Ultrasound receivers.

Accordingly, when one of the providers 205, 206, or 207 enters patient location 203 (e.g., the patient's room), sensors 212 can detect that the provider and patient 214 are commonly occupying patient location 203. Sensors 212 can send input indicating the common occupancy to computer system 201b. Computer system 201b can relay the input to computer system 201a. Computer system 201b (or 201a) can record a time indicative of when the common occupancy was detected.

Subsequently, the provider can leave patient location 203. Sensors 212 in combination with other sensors in the facility (e.g., in the hall outside of patient location 203) can detect that the provider and patient 214 are occupying separate locations within the facility. For example, the sensors can determine that patient 214 is in patient location 214 and the provider is now in the hall outside of patient location 203. The sensors can send input indicating the separate occupancy to computer system 201b. Computer system 201b can relay the input to computer system 201a. Computer system 201b (or 201a) can record a time indicative of when separate occupancy was detected. From the recorded times, computer system 201b (or 201a) can determine the time period of common occupancy (i.e., essentially the amount of time the provider and patient 214 were together in patient location 203).

B. Event Response

Appropriate responses to an alert or alarm of an event can be provided through communication among and between computer systems. The difference between an alert and alarm is one of severity. If a trigger is minimally exceeded, an alert is activated. Typical alert responses include notification of event to the nursing station, establishment of A/V contact with patient, sounding of a tone, or verbally dispatching staff to investigate the situation. Significantly exceeding trigger value or ignored alerts will generate alarms, which typically activate an automatic PDA dispatching of staff, A/V contact and report generation.

Events can be human or computer generated events. For example, a patient attempting to exit a bed or attempting to enter a restricted area are human generated events. On the other hand, expiration of a timer can be a computer generated event. Both human and computer generated events can vary in severity, thus potentially causing alerts or alarms.

Expiration of a time interval can trigger some actionable events. For example, movement of bed bound patients to prevent bed sores or administration of medicine can be required at specified intervals. Computer system 201b can send an alert to computer system 201c (or other appropriate computer systems) when a time interval expires or is about to expire.

However, expiration of time interval can also trigger non-actionable events that cause data processing activities (e.g., checking values in or refining a profile) to occur. For example, at specified time intervals the sufficiency of cumulative staff-to-patient contact times for a patient and/or staff-to-patient ratios for a facility can be automatically checked. Thus, an event response includes a computer system performing data processing activities, for example, in response to expiration of a time interval.

C. Refining Patient Risk Profiles and Modifying Alarm Levels

In some embodiments, stored patient profiles include profiles that include recursively refined patient alarms levels indicative of actionable events requiring a response. For example, a computer system can receive patient sensor data related to a defined event for a patient. The computer system can refine the patient profile based on the received patient sensor data. When appropriate, the computer system can also modify alarm levels for the patient based on the refined profile.

Thus, the occurrence of patient related events can trigger refinement of a patient profile. For example, referring to FIG. 2, in response to determining a time period that a staff member and a patient commonly occupied a portion of a facility, profile manager 230 can access a profile for the patient. Profile manager 230 can identify a quality or performance parameter related to cumulative staff/patient contact time based on data contained in the patient profile. Profile manager 230 can update the value of the quality or performance parameter to reflect the time period of common occupancy between the staff member and the patient. Updating the value can include adding the determined time period to an existing cumulative value. This facilitates tracking cumulative staff-to-patient contact for the patient.

D. Measuring Care and Wellness

Patient care and wellness can be monitored in a variety of ways. According to one embodiment, appropriate care and wellness according to certain parameters can be determined by monitoring the locations and/or movement of patients relative to one or more caregivers.

Generally, a computer system accesses stored patient profiles, which contain data that relate to one or more care or wellness parameters. The computer system identifies one or more care or wellness parameters for each of a plurality of patients based on profile data contained in a corresponding patient profile. Examples of care or wellness parameters can include parameters related to tracking cumulative staff-to-patient contact time, and the like. The computer system determines one or more predetermined locations for each of a plurality of patients relative to one or more predetermined locations for at least one of a caregiver within or without the facility, which are consistent with or that confirm or verify the satisfaction of the one or more identified care or wellness parameters.

Many care and wellness parameters, such as, for example, those related to tracking cumulative staff-to-patient contact time, involve interactions between a patient and a caregiver. Thus, tracking the locations patients and caregivers roughly indicates whether such interactions have actually occurred as prescribed. A patient who is never in the same location as the assigned individual or asset is unlikely to have had the required interaction for a care or wellness parameter to have occurred.

By way of example, patients staff, and assets can be assigned an RFID (or ultrasound) device that can be tracked throughout a facility by means of an RFID (or ultrasound) detection system comprising a plurality of RFID (or ultrasound) detectors throughout the facility. The location of the RFID (or ultrasound) detectors and assignment of RFID (or ultrasound) devices can be recorded and maintained in a computer system. As patients, staff, and assets move throughout the facility and potentially commonly occupy locations within a facility, the RFID (or ultrasound) detectors notify the computer system of RFID (or ultrasound) devices that are currently being detected. Thus, the computer system can correlate the location of each RFID (or ultrasound) device, as well as the duration of each RFID (or ultrasound) device at a specific location, and determine the duration of staff-to-patient contact as well as whether prescribed care and wellness routines or activities involving patients, staff, and/or assets have been properly carried out.

Thus, the computer system can determine the actual locations of the patient and caregiver and compare them with the one or more predetermined locations relating to the one or more identified care or wellness parameters selected to determine if such care or wellness parameters have been satisfied. The location, movement and/or duration of staff-to-patient contact can be used to determine if prescribed duties or activities are actually carried out as prescribed. When appropriate, a response can be initiated to prevent or mitigate harm in the case of an actual event, refining a patient profile and/or generating a care or wellness report.

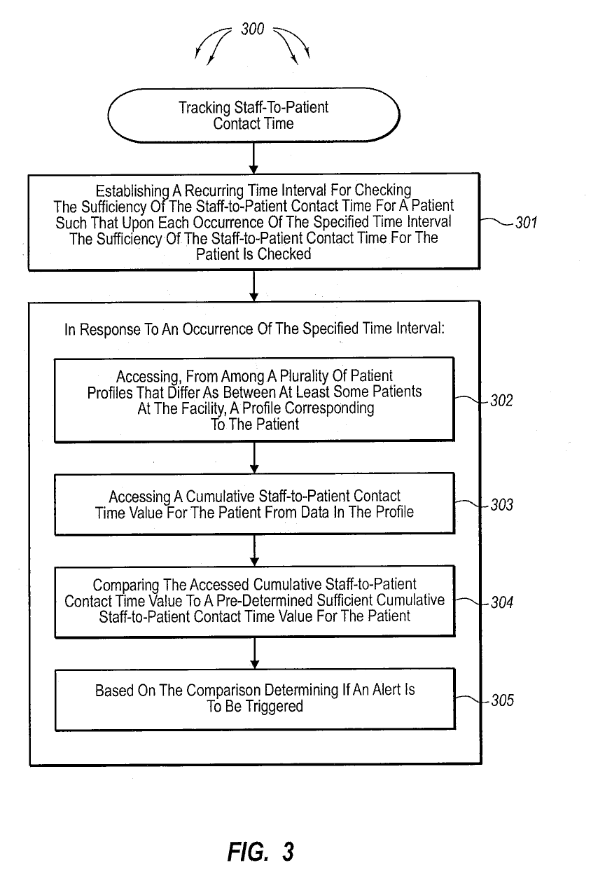

More specifically, the sufficiency of staff-to-patient contact time can be tracked for patients. For example, FIG. 3 is a flow chart that illustrates an exemplary method 300 for tracking staff-to-patient contact time using individualized patent profiles.

Method 300 includes an act of establishing a specified recurring time interval for checking the sufficiency of the staff-to-patient contact time for a patient such that upon each occurrence of the specified time interval the sufficiency of the staff-to-patient contact time for the patient is checked (act 301). For example, a facility master computer system can be configured with a specified time interval (e.g., once a day) when cumulative staff-to-patient contact time for patients at a health care facility is to be checked. Alternately, the specified time interval can be varied on a per patient basis based on patient needs, prior insufficiency of staff-to-patient content for a patient, etc. such that the sufficiency of the staff-to-patient contact time for different patients is checked at different times.

In response to an occurrence the specified time interval, method 300 includes an act of accessing, from among a plurality of patient profiles that differ as between at least some patients at the facility, a profile corresponding to the patient (act 302). For example, referring to FIG. 2, in response to expiration of a time interval, computer system 201a can access profile 224a.

Method 300 includes an act of accessing a cumulative staff-to-patient contact time value for the patient from data in the profile (act 303). For example, computer system 201a can access a cumulative staff-to-patient contact time value(s) from profile 224a. The cumulative staff-to-patient contact time value(s) can indicate the total time staff members (e.g., by staff member type and/or department) have spent with a corresponding patient since the last time the accessed cumulative staff-to-patient contact time value(s) was (were) checked. A cumulative staff-to-patient contact time value can be maintained for the patient per staff subgroup.

Method 300 includes an act comparing the accessed cumulative staff-to-patient contact time to a pre-determined sufficient staff-to-patient contact time value for the patient (act 304). For example, computer system 201 can compare the cumulative staff-to-patient contact time value(s) (e.g., per staff member type and/or department) accessed from profile 224a to corresponding pre-determined sufficient staff-to-patient contact time value(s) for the patient represented in profile 224a. The pre-determined value(s) may be a single value that if not exceeded is indicative of an insufficient level of contact between a patient and staff members. Alternately, one or more pre-set minima and maxima can be utilized to better quantity a level of insufficiency or sufficiency with respect to staff-to-patient contact. A pre-determined sufficient staff-to-patient contact time value can be maintained for the patient per staff subgroup. Thus, it may be that a cumulative staff-to-patient contact time value per subgroup is compared to a corresponding determined sufficient staff-to-patient contact time value per subgroup respectively.

Method 300 includes act of determining if an alert is to be triggered based on the comparison (act 305). For example, if the comparison reveals an insufficient level of staff to patient contact with the patient corresponding to profile 224a, staff members caring for the corresponding patient can be alerted to have increased contact with the patient. If the level of insufficiency exceeds a specified threshold, a supervisor or administrator can also be alerted. A separate alert can be triggered per staff subgroup. Thus, in response to checking sufficiency of the staff-to-patient contact time for patient, a variety of different alerts or combinations thereof can be triggered.

After a staff-to-patient contact time value is checked for a specified time interval, the staff-to-patient contact time value can reset to zero. Thus, the staff-to-patient contact time value can then again begin to accumulate for the next specified time interval. When a plurality of different staff-to-patient contact times are checked (e.g., one per staff subgroup), each of the staff-to-patient contact times can be reset to zero.

Although many care and/or wellness parameters are patient specific, some care and/or wellness parameters may be general parameters related to facility operation. It may be that these general parameters have pre-determined levels of sufficiency either suggested by or dictated by governmental regulations. Thus, although not necessarily related to a specific patient profile, these general parameters are nonetheless tracked from time-to-time as a measure of patient care and wellness to check for deficiencies and/or to insure compliance.

For example, a staff-to-patient ratio can be checked at specified intervals to insure sufficient staffing at a facility. Referring briefly back to FIG. 1, facility master computer 100 can be configured with a recurring time interval for checking the sufficiency of one or more staff-to-patient ratios for a facility. Upon each occurrence of the specified interval, the sufficiency of the staff-to-patient ratio or various different staff-to-patient ratios are checked. A time interval can include a specified amount of time (e.g., ten minutes, one hour, every second, etc.), the occurrence of an event (e.g., intake or discharge of a patient, shift change), etc.

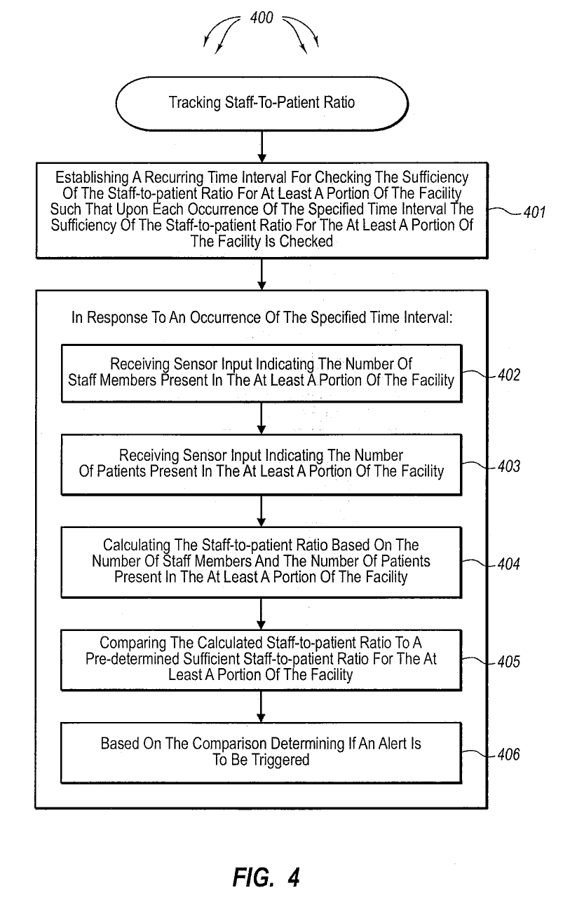

FIG. 4 is a flow chart that illustrates an exemplary method 400 for tracking staff-to-patient ratios at a facility. Staff-to-patient ratios can be tracked facility wide, by department (for staff members or patients), by staff member subgroup or in some combination thereof. Thus, multiple different staff-to-patient ratios can be simultaneously tracked.

Method 400 includes an act of establishing a recurring time interval for checking the sufficiency of the staff-to-patient ratio for at least a portion of the facility such that upon each occurrence of the specified time interval the sufficiency of the staff-to-patient ratio for the at least a portion of the facility is checked (act 401). For example, facility master computer system 100 can establish a recurring time interval (e.g., once a day, at shift change, every second, etc.) for checking the sufficiency of the staff-to-patient ratios for a facility.

In response to an occurrence the time interval, method 400 includes an act of receiving sensor input indicating the number of staff members present in the at least a portion of the facility (act 402). For example, facility master computer system 100 can utilize facility personnel location management 106b to receive (either previously stored or essentially real-time) sensor input indicating the number staff members present in the facility and where the staff members are located. Faculty master computer system 100 can also determine what staff subgroup each staff member is to be included in.

Likewise, method 400 includes an act of receiving sensor input indicating the number of patients present in the at least a portion of the facility (act 403). For example, facility master computer system 100 can utilize patient location management 106d to receive (either previously stored or essentially real-time) sensor input indicating the number of patients present in the facility and where the patients are located.

Method 400 includes an act of calculating the staff-to-patient ratio based on the number of staff members and the number of patients present in the at least a portion of the facility (act 404). For example, facility master computer system 100 can calculate a staff-to-patient ratios based on the number and location of staff members indicated by personnel location management 106a and the number and location of patients indicated by personnel location management 106d. To calculate a staff-to-patient ratio, the quotient of the indicated number of staff members divided by the indicated number of patients can be calculated. Staff-to-patient ratios can be calculated by location (e.g., a specified department) and/or by staff subgroup.

Method 400 includes an act of comparing the calculated staff-to-patient ratio to a pre-determined sufficient staff-to-patient ratio for the at least a portion of the facility (act 405). For example, facility master computer system 100 can compare a calculated staff-to-patient ratio to a pre-determined staff-to-patient ratio. A pre-determined staff-to-patient ratio can be set by facility administration, dictated by government regulations, etc. The pre-determined value may be a single value that if not exceeded is indicative of understaffing at the facility. Similarly, predetermined value may be a single value that if exceeded is indicative of overstaffing. Alternately, one or more pre-set minima and maxima can be utilized to better quantity staffing levels and compliance with governmental regulations.

A pre-determined sufficient staff-to-patient ration can be maintained per location and/or per staff subgroup. Thus, it may be that a staff-to-patient ratio per location and/or per subgroup is compared to a corresponding determined sufficient staff-to-patient ratio per location and/or per staff subgroup respectively.

Method 400 includes act of determining if an alert is to be triggered based on the comparison (act 406). For example, facility master computer system 100 can determine if an alert is to be trigged. Abnormally low or high ratio values can trigger alerts that are sent to a supervisor or facility administrators. A separate alert can be triggered per locations and/or staff subgroup. Thus, in response to checking sufficiency of the staff-to-patient ratios, a variety of different alerts or combinations thereof can be triggered.

### III. Profile Maintenance and Refinement

One, aspect of the inventive monitoring systems and methods for assessing and ensuring quality and performance is the use and refinement of patient specific profiles. Individual profiles permit the inventive patient monitoring systems and methods to more accurately assess the quality of care and wellness of each patient, as among a plurality of patients having a variety of different attributes and needs. Patient profiles permit the inventive systems and methods to better interpret conditions and actions of and interactions between patients and staff that may lead to an actionable or triggering event. This reduces the incidence of false positives and false negatives and may reduce staff response times to critical clinical events.

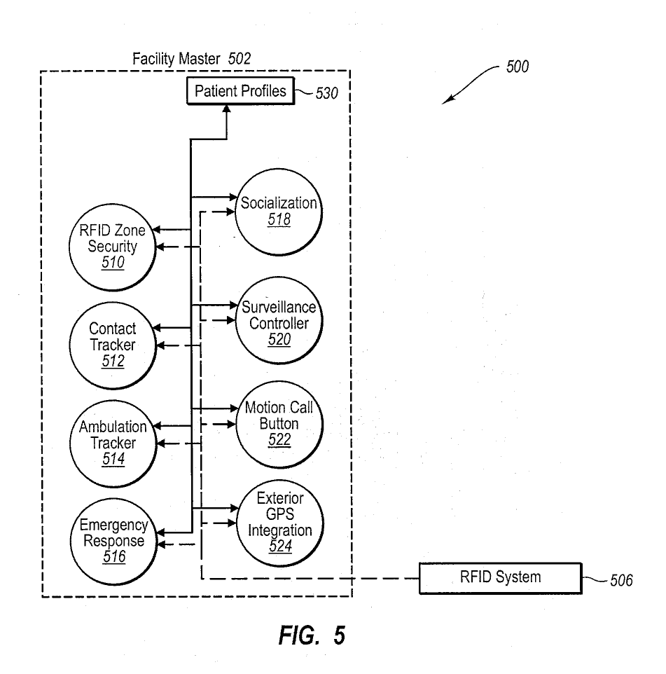

FIG. 5 schematically illustrates an exemplary computer system 500 containing networked computers and interrelated functional modules and peripheral data gathering systems for gathering information regarding a plurality of patients and staff at a healthcare facility and updating patient profiles. Computer system 500 more particularly includes a facility master 502. Of course, computer system 500 may include multiple in room controllers and/or other computers as desired. RFID system 506 interfaces directly with facility master 502 to provide data regarding the location and movements of patients, staff, and assets.

The exemplary modules within facility master 502 include RFID zone security 510 (e.g., to track staff and patient locations relative to secure areas), contact tracker 512, ambulation tracker 514 (e.g., to track total ambulation distance for each patient and staff member), emergency response 516 (e.g., to give evacuation instructions), socialization 518 (e.g., to determine the degree of patient socialization as it may relate to patient care and wellness), surveillance controller 520 (e.g., to detect authorize and unauthorized access to facility locations), mobile call button 522 (e.g., to transmits information regarding a call for help), and exterior GPS integration 524 (e.g., to hand off of patient tracking from the RFID system 506 to GPS when residents travel into an exterior courtyard region of the facility not equipped with RFID zone sensors and/or in cases of patient wandering or flight).

It will be appreciated that additional modules and data generating peripherals may be included as required to generate and process other data types. The data that is processed by the foregoing modules shown in FIG. 5 is used to update or refine patient profiles 530.

Although some of the modules depicted in FIG. 5 are described with respect to RFID, these modules can also be implemented using other technologies, such, as, for example, ultrasound. For example, ultrasound zone security can track staff and patient locations relative to secure areas. Similarly, an ultrasound system can interface directly with facility master 502 to provide data regarding the location and movements of patients, staff, and assets. Ultrasound modules can interoperate with exterior GPS integration 524 to hand off of patient tracking from an ultrasound system to GPS when residents travel into an exterior courtyard region of the facility not equipped with ultrasound zone sensors and/or in cases of patient wandering or flight.

A. Contact Tracker Module

As discussed above, the contact tracker module 512 is typically located in the facility master 502. The purpose is to determine and verify the existence of prescribed patient/staff contacts as they may relate to patient care and wellness and/or staff performance. According to one embodiment, the contact tracker module 512 polls a patient's profile for all elements that require patient/staff contact to be performed and/or delivered on a prescribed schedule, such as, for example, cumulative staff-to-patient contact time.

The RFID system 506 (or similar ultrasound system) is monitored to count each of these events and compare to prescribed standards set within each patient profile. The time period of patient/staff interaction can be measured and compared to pre-set minima and maxima. Alerts and alarms may be generated if an increasing degree of poor staff performance is detected. Data generated by the contact tracker module can be used to assess patient care and wellness and/or staff performance.

B. Patient Profile

The type of data contained in a patient profile can be selected, populated and modified as required depending on any desired care and wellness criteria and/or learned information. The following patient profile is merely one example of a suitable profile for use in collecting and processing data by the modules described above. It is given by way of example, not by limitation. Each line represents an independent inquiry that can be analyzed using one or more computer-monitored data channels. Data may be static or dynamic. Dynamic data can either by altered automatically or manually
S=Static Parameter
AD=Automatically Dynamic Parameter
MD=Manually Dynamic Parameter
Other parameters
.
.
.
C. cumulative doctor-to-patient contact time−x minutes, AD
D. cumulative nurse-to-patient contact time−x minutes, AD
E. cumulative cardiology department staff-to-patient time−x minutes, AD
.
.
.
F. minimum sufficient doctor-to-patient cumulative contact time value per interval—x minutes, MD
G. minimum sufficient nurse-to-patient cumulative contact time value per interval—x minutes, MD
H. minimum sufficient cardiology department-to-patient contact time value per interval—x minutes, MD
.
.
.
Other parameters

Data items C, D, and E, are some examples of types of cumulative staff-to-patient contact times that can be tracked. However, a wide range of other types of cumulative staff-to-patient contact times can also be stored in a patient profile, such as, for example, by other type of skilled worker, by type of non-skilled worker, by health care facility department, etc. Data items C, D, E can be automatically updated as contacts between patients and staff members are detected within a healthcare facility.

Data items F, G, H indicate corresponding minimum sufficient staff-to-patient contact time values per interval. When a time interval occurs, the current value of a cumulative a staff-to-patient contact time is compared to the corresponding minimum sufficient staff-to-patient cumulative contact time value. If the current cumulative value equals or exceeds the minimum sufficient cumulative value, the current cumulative value is deemed sufficient and no alerts are alarms are trigged. On the other hand, if the current cumulative value is below the minimum sufficient cumulative value, the current cumulative value is deemed insufficient and alerts and/or alarms can be trigged. Comparisons can be performed for one or more types of staff-to-patient cumulative time values that are tracked. For example, data item C can be compared to data item F, data item D can be compared to data item G, etc. Data items F, G, and can be manually updated as patients mental and/or physical health changes, to conform with hospital or regulatory policies, etc.

C. Refinement of Profiles

Generally, patient profiles can be maintained and refined. A computer system stores an initial profile for each of a plurality of patients or staff at a facility based on at least one of specific personalized information for each patient or staff, or general information common to more than one individual. The computer system receives collected sensor data relating to each of the patients or staff at the facility. The computer system refines the profile of a patient based on the collected sensor data in order to modify at least one of an alarm level, care or wellness parameter, or a treatment regimen for the patient. The patient profile can be updated by way of an information feedback loop in which potentially actionable events are confirmed or denied through human intervention.

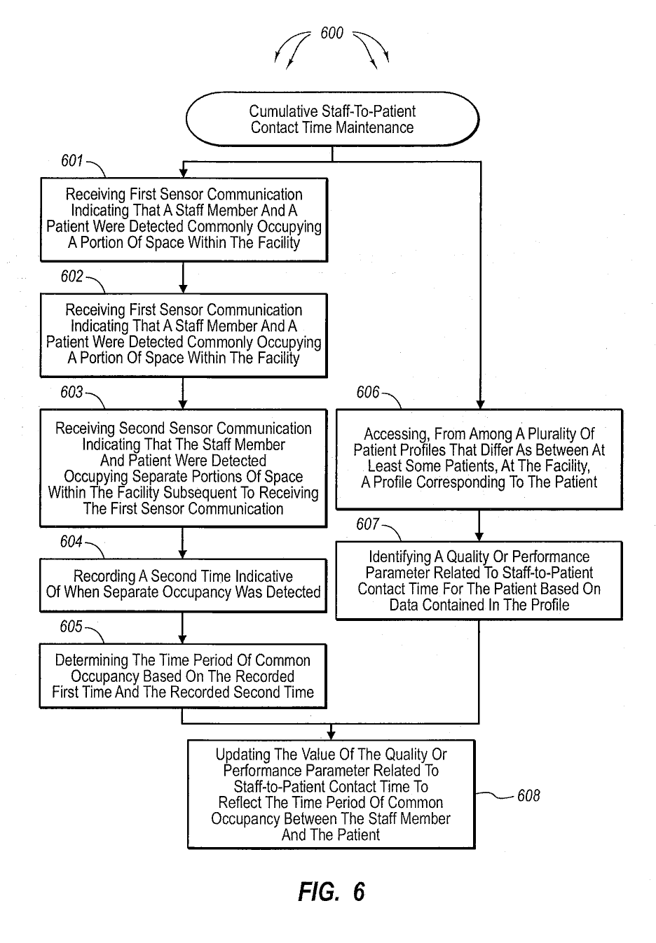

More specifically, a profile can be refined to track cumulative staff-to-patient contact time for a patient. For example, FIG. 6 illustrates a flow chart of an exemplary method 600 for maintaining cumulative staff-to-patient contact time for a patient. Method 800 will be described with respect to the components of FIG. 2 and FIG. 5.

Method 600 includes an act of receiving first sensor communication indicating that a staff member and a patient were detected commonly occupying a portion of space within the facility (act 601). For example, an RFID (or ultrasound) receiver included in sensors 212 can detect that an RFID (or ultrasound) transmitter for patient 214 and an RFID transmitter for provider 207 are both present at patient location 203. The RFID (or ultrasound) receiver can communicate an indication that it has detected both of the RFID (or ultrasound) transmitters at patient location 203 to computer system 201b. Computer system 201b can receive the sensor communication indicating that the RFID (or ultrasound) transmitters were detected at patient location 203.

Method 600 includes an act of recording a first time indicative of when common occupancy in the portion of space was detected (act 602). For example, computer system 201b can record the time it received the first sensor communication from the RFID (or ultrasound) receiver.

Method 600 includes an act of receiving second sensor communication indicating that the staff member and patient were detected occupying separate portions of space within the facility subsequent to receiving the first sensor communication (act 603). For example, the RFID (or ultrasound) receiver included in sensors 212 can detect that the RFID (or ultrasound) transmitter for patient 214 is present at patient location 203 but that the RFID (or ultrasound) transmitter for provider 207 is no longer present at patient location 203. Other RFID (or ultrasound) receivers can detect that an RFID (or ultrasound) transmitter for provider 207 is present in a separate portion of space in the facility (e.g., in the hall outside of patient location 203). Collectively, the RFID (or ultrasound) receivers can send communication that patient 214's RFID (or ultrasound) transmitter was detected at patient location 203, while provider 207's RFID (or ultrasound) transmitter was detected outside of patient location 203. Computer system 201b can receive the sensor communication indicating that the RFID (or ultrasound) transmitters were detected in separate portions of space.

Method 600 includes an act of recording a second time indicative of when separate occupancy was detected (act 604). For example, computer system 201b can record the time it received the second sensor communication from the RFID (or ultrasound) receivers. Method 600 includes an act of determining the time period (e.g., in minutes) of common occupancy based on the recorded first time and the recorded second time (act 605). For example, computer system 201b can calculate the period of time provider 207 and patient 214 commonly occupied patient location 203. To calculate the time period of common occupancy, computer system 201b can calculate the difference of subtracting the recorded first time from the recorded second time.

In some embodiments, a healthcare facility has sufficient sensors and network infrastructure that staff members and patients are monitored essentially continuously as they move through out the healthcare facility. In these embodiments, a facility master system can determine directly from sensor communication when common occupancy of a portion of the healthcare facility is detected. For example, when the facility master computer system receives sensor communication indicating that a patient RFID (or ultrasound) signal and a staff member RFID (or ultrasound) signal were detected in the same location, the facility master computer system can identify a time period of common occupancy by the corresponding patient and staff member.

In other embodiments, sensors are placed at one or more “choke points” within a healthcare facility. A choke point can be a doorway, hallway, or other location within a healthcare facility. When staff members and/or patients are detected passing through the choke point, the facility master computer system can infer common or separate occupancy by the corresponding patient and staff member. From inferred common and/or separate occupation, a facility master computer system can derive a period of common occupancy. For example, if a patient RFID (or ultrasound) signal and a staff member RFID (or ultrasound) signal are both detected entering a doorway into a treatment room, the facility master computer system can infer a begin time that common occupancy of the treatment room by the staff member and patient began. Subsequently, when one or both of the patient RFID (or ultrasound) signal and staff member RFID (or ultrasound) signal are detecting entering the doorway to leave the treatment room, the facility master computer system can infer an end time: that common occupancy of treatment room by the staff member and patient ended.

Method 600 includes an act of accessing, from among a plurality of patient profiles that differ as between at least some patients at the facility, a profile corresponding to the patient (act 606). For example, computer system 201b can access profile 224. Method 600 includes an act of identifying a quality or performance parameter related to staff/patient contact time for the patient based on data contained in the profile (act 607). For example, computer system 301b can identify a quality or performance parameter a similar to criteria “C. cumulative doctor-to-patient contact time−x minutes, AD” for patient 214.

Method 600 includes an act of updating the value of the quality or performance parameter to reflect the time period of common occupancy between the staff member and the patient. (act 608). For example, computer system 201b can update a quality or performance parameter similar to criteria “C. cumulative doctor-to-patient contact time−x minutes, AD” for patient 214. To update the quality or performance parameter, computer system 201b can add the determined time period of common occupancy for provider 207 and patient 214 (e.g., in minutes) to an existing value for the quality or performance parameter. Accordingly, a cumulative value for staff-to-patient contact times (however stratified) can be maintained and tracked.

Alternately, sensor communication received at computer system 201b can be relayed to computer system 201a. Referring briefly to FIG. 5, computer system 201a can utilize a module similar contact tracker 512 to calculate and update cumulative staff-to-patient contact times for a patient.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system in a healthcare facility system that includes a plurality of patients and staff who interact so as to provide care and wellness for the patients, a method for maintaining cumulative staff-to-patient contact time for a patient, the method comprising:
detecting a period of contact time over which a patient and a staff member were within a specified physical proximity of one another at the healthcare facility;
accessing, from among a plurality of patient profiles that differ as between at least some patients at the facility, a profile corresponding to the patient;
identifying a current value for a quality or performance parameter indicative of the cumulative staff-to-patient contact time for the patient from within the accessed profile; and
adding the period of contact time to the current value of the quality or performance parameter to update the indicated cumulative staff-to-patient contact time for the patient.

2. The method as recited in claim 1, wherein detecting a period of contact time over which a patient and a staff member were within a specified physical proximity of one another comprises detecting a period of contact time over which a patient and a healthcare facility worker were within a specified physical proximity of one another.

3. The method as recited in claim 2, wherein the healthcare facility worker is selected from among a doctor, a nurse, a nursing assistant, a physical therapist, an occupational therapist, housecleaning personnel, a social worker, and a speech therapist.

4. The method as recited in claim 2, wherein identifying a current value for a quality or performance parameter indicative of the cumulative staff-to-patient contact time for the patient comprises an act of identifying a current value for a quality or performance parameter indicative of the cumulative staff-to-patient contact time for the patient for one or more subgroups of healthcare facility staff.

5. The method as recited in claim 2, wherein identifying a current value for a quality or performance parameter indicative of the cumulative staff-to-patient contact time for the patient comprises an act of identifying a current value for a quality or performance parameter indicative of the cumulative nurse-to-patient contact time for the patient.

6. The method as recited in claim 1, wherein adding the period of contact time to the current value of the quality or performance parameter to update the indicated cumulative staff-to-patient contact time comprises adding the period of contact time to a current value of the quality or performance parameter, for a specified healthcare facility staff subgroup, based on the type of staff member that participated in contact with the patient.

7. At a computer system in a healthcare facility system that includes a plurality of patients and staff who interact so as to provide care and wellness for the patients, a method for maintaining cumulative staff-to-patient contact time for a patient, the method comprising:
receiving first sensor communication indicating that a staff member and a patient were detected commonly occupying a portion of space within the facility;
recording a first time indicative of when common occupancy in the portion of space was detected;
receiving second sensor communication indicating that the staff member and patient were detected occupying separate portions of space within the facility subsequent to receiving the first sensor communication;
recording a second time indicative of when separate occupancy was detected;
determining the time period of common occupancy based on the recorded first time and the recorded second time;
accessing, from among a plurality of patient profiles that differ as between at least some patients at the facility, a profile corresponding to the patient;
identifying a quality or performance parameter related to staff-to-patient contact time for the patient based on data contained in the profile; and
updating the value of the quality or performance parameter related to staff-to-patient contact time to reflect the time period of common occupancy between the staff member and the patient.

8. The method as recited in claim 7, wherein the receiving first and second sensor communication comprises an act of receiving communication from one or more RFID receivers.

9. The method as recited in claim 8, wherein receiving first sensor communication indicating that a staff member and a patient were detected commonly occupying a portion of space within the facility comprises receiving communication from one or more RFID receivers indicating that an RFID transmitter for the staff member and an RFID transmitter for the patient were detected commonly occupying a portion of space within the facility.

10. The method as recited in claim 8, wherein receiving second sensor communication indicating that the staff member and patient were detected occupying separate portions of space within the facility comprises receiving communication from one or more RFID receivers indicating that an RFID transmitter for the staff member was detected in a first location and an RFID transmitter for the patient was detected in a second different location.

11. The method as recited in claim 7, wherein the receiving first and second sensor communication comprises an act of receiving communication from one or more Ultrasound receivers.

12. The method as recited in claim 11, wherein receiving first sensor communication indicating that a staff member and a patient were detected commonly occupying a portion of space within the facility comprises receiving communication from one or more ultrasound receivers indicating that an ultrasound transmitter for the staff member and an ultrasound transmitter for the patient were detected commonly occupying a portion of space within the facility.

13. The method as recited in claim 8, wherein receiving second sensor communication indicating that the staff member and patient were detected occupying separate portions of space within the facility comprises receiving communication from one or more ultrasound receivers indicating that an ultrasound transmitter for the staff member was detected in a first location and an ultrasound transmitter for the patient was detected in a second different location.

14. The method as recited in claim 7, wherein determining the time period of common occupancy based on the recorded first time and the recorded second time comprises subtracting the recorded first time from the recorded second time.

15. The method as recited in claim 7, wherein identifying a quality or performance parameter related to staff-to-patient contact time for the patient based on data contained in the profile comprises accessing a cumulative staff-to-patient contact time value.

16. The method as recited in claim 7, wherein updating the value of the quality or performance parameter related to staff-to-patient contact time to reflect the time period of common occupancy comprises an act of adding the determined time period to a cumulative staff-to-patient contact time value in the profile.

17. The method as recited in claim 7, wherein receiving first sensor communication indicating that a staff member and a patient were detected commonly occupying a portion of space within the facility comprises:
an act of receiving sensor communication from sensors at a choke point within the healthcare facility indicating that a staff member passed through the choke point to enter a specified portion of the healthcare facility;
an act of receiving sensor communication from sensors at a choke point within the healthcare facility indicating that a patient passed through the choke point to enter the specified portion of the healthcare facility; and
an act of inferring a begin time from the collective received sensor inputs that common occupancy of the specified portion of the healthcare facility by the staff member and patient began.

18. The method as recited in claim 17, wherein receiving second sensor communication indicating that the staff member and patient were detected occupying separate portions of space within the facility subsequent to receiving the first sensor communication;
an act of receiving sensor communication from sensors at the choke point within the healthcare facility indicating that at least one of the staff member and the patient passed through the choke point to leave the specified portion of the healthcare facility;
an act of inferring a end time from the collective received sensor inputs that common occupancy of the specified portion of the healthcare facility by the staff member and patient ended.

19. The method of claim 18, wherein determining the time period of common occupancy comprises an act of deriving the time period of common occupancy based on the begin time and the end time.

20. The method as recited in claim 19, wherein updating the value of the quality or performance parameter related to staff-to-patient contact time comprises updating a staff-to-patient contact time value in the patient profile to reflect the time period of common occupancy that was determined based on the inferred begin time and the inferred end time.

21. At a computer system in a healthcare facility system that includes a plurality of patients and staff who interact so as to provide care and wellness for the patients, a method for tracking a staff-to-patient contact time at the facility comprising:
establishing a specified recurring time interval for checking the sufficiency of the staff-to-patient contact time for a patient such that upon each occurrence of the specified time interval the sufficiency of the staff-to-patient contact time for the patient is checked;
in response to an occurrence of the specified time interval:
accessing, from among a plurality of patient profiles that differ as between at least some patients at the facility, a profile corresponding to the patient;
accessing a cumulative staff-to-patient contact time value for the patient from data in the profile;
comparing the accessed cumulative staff-to-patient contact time value to a pre-determined sufficient staff-to-patient cumulative contact time value for the patient;
based on the comparison determining if an alert is to be triggered.

22. The method as recited in claim 21, wherein establishing a specified recurring time interval for checking the sufficiency of the staff-to-patient contact time for a patient comprises establishing a patient specific recurring time interval based on prior events related to the sufficiency of the staff-to-patient contact time for the patient.

23. The method as recited in claim 21, wherein establishing a specified recurring time interval for checking the sufficiency of the staff-to-patient contact time for a patient comprises establishing a specified time interval for checking the sufficiency of the staff-to-patient contact time on a daily basis.

24. The method as recited in claim 21, wherein based on the comparison determining if an alert is to be triggered comprises triggering an alert in response to a determination that the staff-to-patient contact time for the patient was insufficient.

25. The method as recited in claim 24, wherein triggering an alert in response to a determination that the staff-to-patient contact time for the patient was insufficient comprises triggering an alert in response to a determination that the staff-to-patient contact time for the patient was insufficient for a specified staff subgroup.

26. The method as recited in claim 24, wherein triggering an alert in response to a determination that the staff-to-patient contact time for the patient for the patient was insufficient comprises triggering an alert based on prior events related to the sufficiency of the staff-to-patient contact time for the patient.

27. The method as recited in claim 24, wherein triggering an alert in response to a determination that the staff-to-patient contact time for the patient for the patient was insufficient comprises sending an electronic message to staff members caring for the patient encouraging them to increase contact time with the patient.

28. The method as recited in claim 21, further comprising initiating a response to the alert.

29. The method as recited in claim 21, wherein accessing a cumulative staff-to-patient contact time value for the patient from data in the profile comprises accessing a staff-to-patient contact time value indicating the total time staff members have been in contact with the patient since a prior occurrence of the specified time interval.

30. The method as recited in claim 21, wherein accessing a cumulative staff-to-patient contact time value for the patient from data in the profile comprises accessing a cumulative staff-to-patient contact time value for one or more staff subgroups.

31. The method as recited in claim 21, wherein comparing the accessed cumulative staff-to-patient contact time value to a pre-determined sufficient staff-to-patient contact time value for the patient comprises comparing the accessed cumulative staff-to-patient contact time value to a pre-determined sufficient staff-to-patient contact time value contained in the accessed profile.

32. The method as recited in claim 21, wherein comparing the accessed cumulative staff-to-patient contact time value to a pre-determined sufficient staff-to-patient contact time value contained in the accessed profile comprises comparing the accessed cumulative staff-to-patient contact time value from one or more staff subgroups to corresponding pre-determined sufficient staff-to-patient contact time values for the one or more staff subgroups respectively.

33. At a computer system in a healthcare facility system that includes a plurality of patients and staff who interact so as to provide care and wellness for the patients, a method for tracking a staff-to-patient ratio at the facility comprising:
establishing a recurring time interval for checking the sufficiency of the staff-to-patient ratio for at least a portion of the facility such that upon each occurrence of the specified time interval the sufficiency of the staff-to-patient ratio for the at least a portion of the facility is checked;
in response to an occurrence the time interval:
receiving sensor input indicating the number of staff members present in at least a portion of the at least a portion of the facility;
receiving sensor input indicating the number of patients present in the at least a portion of the facility;
calculating the staff-to-patient ratio based on the number of staff members and the number of patients present in the at least a portion of the facility;
comparing the calculated staff-to-patient ratio to a pre-determined sufficient staff-to-patient ratio for the at least a portion of the facility;
based on the comparison determining if an alert is to be triggered.

34. The method as recited in claim 33, wherein establishing a recurring time interval for checking the sufficiency of the staff-to-patient ratio comprises establishing a recurring time interval for continuously checking the staff-to-patient ratio.

35. The method as recited in claim 33, wherein establishing a recurring time interval for checking the sufficiency of the staff-to-patient ratio for at least a portion of the facility comprises establishing a recurring time interval for checking the sufficiency of the staff-to-patient ratio for a specified department within the healthcare facility.

36. The method as recited in claim 33, wherein establishing a recurring time interval for checking the sufficiency of the staff-to-patient ratio for at least a portion of the facility comprises establishing a recurring time interval for checking the sufficiency of the staff-to-patient ratio for a specified staff member subgroup at the healthcare facility.

37. The method as recited in claim 33, wherein establishing a recurring time interval for checking the sufficiency of the staff-to-patient ratio comprises establishing a recurring time interval for checking the sufficiency of staff-to-patient ratios on a daily basis.

38. The method as recited in claim 33, wherein receiving sensor input indicating the number of staff members present in the facility comprises receiving input from one or more RFID receivers that have detected RFID signals corresponding to staff members.

39. The method as recited in claim 33, wherein receiving sensor input indicating the number of patients present in the facility comprises receiving input from one or more RFID receivers that have detected RFID signals corresponding to patients.

40. The method as recited in claim 33, wherein receiving sensor input indicating the number of staff members present in the facility comprises receiving input from one or more ultrasound receivers that have detected ultrasound waves corresponding to staff members.

41. The method as recited in claim 33, wherein receiving sensor input indicating the number of patients present in the facility comprises receiving input from one or more Ultrasound receivers that have detected Ultrasound waves corresponding to patients.

42. The method as recited in claim 33, wherein calculating the staff-to-patient ratio based on the number of staff members and the number of patients present in the at least a portion of the facility comprises calculating a staff-to-patient ratio for a specified department of the healthcare facility.

43. The method as recited in claim 33, wherein calculating the staff-to-patient ratio based on the number of staff members and the number of patients present in the at least a portion of the facility comprises calculating a staff-to-patient ratio for a specified staff member subgroup at the healthcare facility.

44. The method as recite in claim 33 wherein based on the comparison determining if an alert is to be triggered comprises an act determining that the staff-to-patient ratio is abnormally low or abnormally high.

45. The method as recite in claim 33, wherein based on the comparison determining if an alert is to be triggered comprises an act determining that the staff-to-patient ratio does not comply with governmental regulations.

46. At a computer system in a healthcare facility system that includes a plurality of patients and staff who interact so as to provide care and wellness for the patients, a method for managing cumulative staff-to-patient contact times patients, the method comprising:
for each of a plurality of patients at the healthcare facility:
monitoring periods of common occupancy between the patient and members of a plurality of different subgroups of healthcare facility staff,
maintaining a cumulative staff-to-patient contact time value for the patient for each of the plurality of different subgroups of healthcare facility staff,
comparing the maintained cumulative staff-to-patient contact time value for each of the plurality of different subgroups to corresponding sufficient cumulative staff-to-patient contact time values for the patient for each of the plurality of subgroups in response to the occurrence of a once daily time interval;
issuing an alert or an alarm for any subgroup having an in sufficient maintained cumulative staff-to-patient contact time value for the patient based on the comparison; and
resetting the maintained cumulative staff-to-patient contact time value for the patient for each of the plurality of different subgroups to zero after issuing any alerts or alarms.

47. A computer program product for use at a computer system in a healthcare facility system that includes a plurality of patients and staff who interact so as to provide care and wellness for the patients, the computer program product for implementing a method for maintaining cumulative staff-to-patient contact time for a patient, the computer program product comprising one or more physical storage media having stored thereon computer-executable instructions that, when executed at a processor, cause the computer system to perform the method, including the following:
detect a period of contact time over which a patient and a staff member were within a specified physical proximity of one another at the healthcare facility;
access, from among a plurality of patient profiles that differ as between at least some patients at the facility, a profile corresponding to the patient;
identify a current value for a quality or performance parameter indicative of the cumulative staff-to-patient contact time for the patient from within the accessed profile; and
add the period of contact time to the current value of the quality or performance parameter to update the indicated cumulative staff-to-patient contact time for the patient.

48. A computer program product for use at a computer system in a healthcare facility system that includes a plurality of patients and staff who interact so as to provide care and wellness for the patients, the computer program product for implementing a method for maintaining cumulative staff-to-patient contact time for a patient, the computer program product comprising one or more physical storage media having stored thereon computer-executable instructions that, when executed at a processor, cause the computer system to perform the method, including the following:
receive first sensor communication indicating that a staff member and a patient were detected commonly occupying a portion of space within the facility;
record a first time indicative of when common occupancy in the portion of space was detected;
receive second sensor communication indicating that the staff member and patient were detected occupying separate portions of space within the facility subsequent to receiving the first sensor communication;
record a second time indicative of when separate occupancy was detected;
determine the time period of common occupancy based on the recorded first time and the recorded second time;
access, from among a plurality of patient profiles that differ as between at least some patients at the facility, a profile corresponding to the patient;
identify a quality or performance parameter related to staff-to-patient contact time for the patient based on data contained in the profile; and
update the value of the quality or performance parameter related to staff-to-patient contact time to reflect the time period of common occupancy between the staff member and the patient.

49. A computer program product for use at a computer system in a healthcare facility system that includes a plurality of patients and staff who interact so as to provide care and wellness for the patients, the computer program product for implementing a method for tracking a staff-to-patient contact time at the, the computer program product comprising one or more physical storage media having stored thereon computer-executable instructions that, when executed at a processor, cause the computer system to perform the method, including the following:
establish a specified recurring time interval for checking the sufficiency of the staff-to-patient contact time for a patient such that upon each occurrence of the specified time interval the sufficiency of the staff-to-patient contact time for the patient is checked;
in response to an occurrence of the specified time interval:
access, from among a plurality of patient profiles that differ as between at least some patients at the facility, a profile corresponding to the patient;
access a cumulative staff-to-patient contact time value for the patient from data in the profile;
compare the accessed cumulative staff-to-patient contact time value to a predetermined sufficient staff-to-patient contact time value for the patient;
based on the comparison determining if an alert is to be triggered.

50. A computer program product for use at a computer system in a healthcare facility system that includes a plurality of patients and staff who interact so as to provide care and wellness for the patients, the computer program product for implementing a method for tracking a staff-to-patient ratio at the facility, the computer program product comprising one or more physical storage media having stored thereon computer-executable instructions that, when executed at a processor, cause the computer system to perform the method, including the following:
establish a recurring time interval for checking the sufficiency of the staff-to-patient ratio for at least a portion of the facility such that upon each occurrence of the specified time interval the sufficiency of the staff-to-patient ratio for the at least a portion of the facility is checked;
in response to an occurrence the time interval:
receive sensor input indicating the number of staff members present in at least a portion of the at least a portion of the facility;
receive sensor input indicating the number of patients present in the at least a portion of the facility;
calculate the staff-to-patient ratio based on the number of staff members and the number of patients present in the at least a portion of the facility;
compare the calculated staff-to-patient ratio to a pre-determined sufficient staff-to-patient ratio for the at least a portion of the facility;
based on the comparison determining if an alert is to be triggered.

51. A computer program product for use at a computer system in a healthcare facility system that includes a plurality of patients and staff who interact so as to provide care and wellness for the patients, the computer program product for implementing a method for managing cumulative staff-to-patient contact times patients, the computer program product comprising one or more physical storage media having stored thereon computer-executable instructions that, when executed at a processor, cause the computer system to perform the method for each of a plurality of patients at the healthcare facility, including the following:
monitor periods of common occupancy between the patient and members of a plurality of different subgroups of healthcare facility staff;
maintain a cumulative staff-to-patient contact time value for the patient for each of the plurality of different subgroups of healthcare facility staff;
compare the maintained cumulative staff-to-patient contact time value for each of the plurality of different subgroups to corresponding sufficient cumulative staff-to-patient contact time values for the patient for each of the plurality of subgroups in response to the occurrence of a once daily time interval;
issue an alert or an alarm for any subgroup having an in sufficient maintained cumulative staff-to-patient contact time value for the patient based on the comparison; and
reset the maintained cumulative staff-to-patient contact time value for the patient for each of the plurality of different subgroups to zero after issuing any alerts or alarms.
